(19) United States
(12) Patent Application Publication
(10) Pub. No.: US 2020/0015245 A1
(43) Pub. Date: Jan. 9, 2020

(54) UE SELECTION AND TRANSMISSION RANK ESTIMATION FOR MU-MIMO COMMUNICATION SYSTEMS

(71) Applicant: NEC Corporation, Tokyo (JP)

(72) Inventors: Yasushi MARUTA, Tokyo (JP); Duong PHAM, Victoria (AU)

(73) Assignee: NEC Corporation, Tokyo (JP)

(21) Appl. No.: 16/326,531

(22) PCT Filed: Feb. 27, 2017
(86) PCT No.: PCT/JP2017/009109

§ 371 Date: Feb. 19, 2019

(30) Foreign Application Priority Data
Aug. 23, 2016 (AU) 2016-903340

(51) Int. Cl. H04W 72/12; H04W 72/06; H04W 72/08; H04B 7/0452; H04B 7/08

(52) U.S. Cl. CPC H04W 72/1226; H04W 72/121; H04W 72/1247; H04B 7/0857; H04W 72/082; H04B 7/0452; H04W 72/06

(57) ABSTRACT

A method of scheduling transmission in a MIMO system is provided that includes joint UE and rank selection. The method comprises selecting, at a base station, a UE of a plurality of candidate UEs and a MIMO rank for the selected UE according to an inter-UE interference between the selected UE at the MIMO rank and one or more scheduled UEs. The selected UE is then scheduled for transmission, at the MIMO rank, with the scheduled UEs.

### TECHNICAL FIELD

The present invention relates to control signalling in advanced wireless communication networks, and in particular in MU-MIMO communication systems.

### Abbreviations

The following abbreviations are used herein:
DL Down Link
FDD Frequency-division duplexing
MIMO Multiple Input Multiple Output
MU Multiple User
SU Single User
TDD Time-division duplexing
UE User Equipment

### BACKGROUND ART

Wireless communication systems are widely known in which base stations (also known as eNodeBs (eNBs)) communicate with mobile devices (also known as user equipments (UEs)) which are within range of the eNB. Each eNB divides its available bandwidth, i.e. frequency and time resources, into different resource allocations for the different UEs. There is a constant need to increase the capacity of such systems, and to improve the efficiency of resource utilisation, in order to accommodate more users (more UEs), more data-intensive services and/or higher data transmission rates.

Multiple-input multiple-output (MIMO) schemes employ multiple antennae at the transmitter and/or at the receiver (often at both) to enhance the data capacity achievable between the transmitter and the receiver. Typically, this is used to achieve enhanced data capacity between an eNB and the UE(s) served by that eNB.

FIG. 1 illustrates a general MU-MIMO system 100, according to the prior art, including a base station (eNB) 105 equipped with N_{TX} antennas and N UEs.

The eNB 105 selects a number of UEs 110 for scheduling, and assigns a transmission rank to the scheduled UEs 110. The total number of scheduled ranks must not exceed the number of layers L_{MAX} that the eNB 105 can provide.

For those scheduled UEs 110, the eNB 105 transmits data to them on the same time-frequency from multiple transmit antennas. To minimise interference between the UEs, the eNodeB creates transmission beams through precoding. Mathematically, the received signal at the i-th UE is described as follows:

$$y ( i ) {\sum }_{k = 1}^{{N}_{UE}} H ( i ) V ( k ) x ( k ) + n ( i ) \qquad ( Equation 1 )$$

where:
y(i) is the received signal at the i-th UE,
x(i) is the data signal for the i-th UE,
H(i) is the channel matrix of the i-th UE,
V(i) is the precoder matrix of the i-th UE,
n(i) is the additive white Gaussian noise at the i-th UE.

The precoder is generated based upon a downlink channel status or a downlink channel estimate from the UEs 110. In a TDD system, the downlink channel estimate can be available via estimation of the uplink channel and in a FDD system the downlink channel can be estimated using the UE feedbacks. FIG. 2 illustrates a downlink and uplink transmission mechanism between the eNB 105 and the UEs 110 of the system 100.

### SUMMARY OF INVENTION

### Technical Problem

A problem with MIMO systems of the prior art is that they do not fully utilise the available bandwidth, and thus operate inefficiently. In particular, inter-UE interference often causes inefficient utilisation of bandwidth.

Accordingly, there is a need for an improved MIMO communications in advanced wireless networks.

It will be clearly understood that, if a prior art publication is referred to herein, this reference does not constitute an admission that the publication forms part of the common general knowledge in the art in Australia or in any other country.

### Solution to Problem

The present invention is directed to MIMO systems, and method for MIMO systems, which may at least partially overcome at least one of the abovementioned disadvantages or provide the consumer with a useful or commercial choice.

With the foregoing in view, the present invention in one form, resides broadly in a method of scheduling transmission in a MIMO system comprising a base station, one or more scheduled UEs and a plurality of candidate UEs, the method comprising:

selecting, at the base station, a UE of the candidate UEs and a MIMO rank for the selected UE according to an inter-UE interference between the selected UE at the MIMO rank and the scheduled UEs; and

scheduling the UE for transmission, at the MIMO rank, with the scheduled UEs.

Preferably, the inter-UE interference is determined according to a signal-to-interference-plus-noise ratio (SINR) of the selected UE and each of the scheduled UEs.

Preferably, the UE is selected by:

determining an inter-UE interference for each of the candidate UEs and the scheduled UEs; and

selecting the UE of the candidate UEs according to the determined inter-UE interferences.

Preferably, the inter-UE interference for each of the candidate UEs is determined for each of a plurality of MIMO ranks, and the UE and MIMO rank are jointly selected according to the determined inter-UE interferences.

The method may further comprise: determining a composite precoder for each of the candidate UEs and the scheduled UEs, and determining the inter-UE interference using the composite precoders and channel estimates.

The precoder may be determined according to singular value decomposition (SVD) of a channel estimate.

Preferably, the selected UE (î) and rank (rᵢ) is selected according to:

$$SINR ( {n}_{SB} , \hat{k} , r , l ) = \frac{ρ}{{[ \begin{matrix}{ρ}^{- 1} I + \\ W {( {n}_{SB} , \hat{k} , r )}^{H} {H ( {n}_{SB} , \hat{k} )}^{H} H ( {n}_{SB} , \hat{k} ) W ( {n}_{SB} , \hat{k} , r )\end{matrix} ]}_{ll}^{- 1}} - 1$$

$$ρ = \frac{{N}_{RX}}{r} SINR ( {n}_{SB} , \hat{k} )$$

$${n}_{SB} , = 1 , … , {N}_{SB} , r = 1 , … , {N}_{RX} ( \hat{k} ) , l = 1 , … , r$$

where:
Ω is the set of candidate UEs;
N_{RX}(i) is the number of receiver channels at UE i;
Φ is the set of scheduled UEs;
N_{SB} is the number of subbands in the bandwidth;
rₖ is the rank of UE k; and
wᵢ is the weight of UE i. For proportional fair scheduling, the weight may be the reciprocal of the average transmission rate of user i.

Preferably, SINR(n_{SB},i,r,l) is determined according to:

$$SINR ( {n}_{SB} , i , r , l ) = \frac{ρ}{{[ {ρ}^{- 1} I + {W ( {n}_{SB} , i , r )}^{H} {H ( {n}_{SB} , i )}^{H} H ( {n}_{SB} , i ) W ( {n}_{SB} , ir ) ]}_{H}^{- 1}} - 1$$

$$ρ = \frac{{N}_{RX}}{r} SNR ( {n}_{SB} , i )$$

$${n}_{SB} , = 1 , … , {N}_{SB} , r = 1 , … , {N}_{RX} ( i ) , l = 1 , … , r ;$$

and
SINR(n_{SB},[i,r],k,l) is determined according to:

$$SINR ( {n}_{SB} , [ i , r ] , k , l ) = \frac{ρ}{{[ {ρ}^{- 1} I + {W ( {n}_{SB} , [ i , r ] , k )}^{H} {H ( {n}_{SB} , k )}^{H} H ( {n}_{SB} , k ) W ( {n}_{SB} , [ i , r ] , k ) ]}_{H}^{- 1}} - 1$$

$$ρ = \frac{{N}_{RX}}{{r}_{k}} SNR ( {n}_{SB} , k )$$

$${n}_{SB} , = 1 , … , {N}_{SB} , l = 1 , … , {r}_{k}$$

where
W(n_{SB},i,r) is a precoder;
H(n_{SB},i) is a channel estimate;
N_{RX}(i) is a number of receiver channels at UE i;
rₖ is a rank of UE k; and
SNR is a signal to noise ratio.

Preferably, the precoder W(n_{SB},i,r) is determined according to:

$$W ( {n}_{SB} , i , r ) = [ \begin{matrix}{P}_{1 , {N}_{i}} & ⋯ & {P}_{1 , {N}_{i} + r - 1} \\ ⋮ & ⋮ & ⋮ \\ {P}_{{N}_{TX} , {N}_{i}} & ⋯ & {P}_{{N}_{TX} , {N}_{i} + r - 1}\end{matrix} ] , {N}_{i} = 1 + {\sum }_{k = 1}^{\vert Φ \vert} R ( k ) , r = 1 , 2 , … , {N}_{RX} ( i )$$

$$P ( {n}_{SB} , i , r ) = {{F ( {n}_{SB} , i , r )}^{H} [ F ( {n}_{SB} , i , r ) {F ( {n}_{SB} , i , r )}^{H} + α ]}^{- 1} , r = 1 , … , {N}_{RX} ( i )$$

where
F is a composite representative channel; and
N_{RX}(i) is a number of receiver antennas at UE i.

Preferably, the scheduled UEs include a first UE, which was selected to be scheduled based upon a smallest correlation with other UEs according to channel estimates.

Preferably, the first UE (\hat{k}) is selected according to

$$\hat{k} = {arg min}_{k ∈ Ω} {\sum }_{{n}_{SB} = 1}^{{N}_{SB}} {\sum }_{i ∈ Ω , i \neq k} tr \{ {[ H ( {n}_{SB} , i ) {H ( {n}_{SB} , k )}^{H} ]}^{H} [ H ( {n}_{SB} , i ) {H ( {n}_{SB} , k )}^{H} ] \}$$

where
Ω is the set of candidate UEs;
N_{SB} is the number of subbands in the bandwidth; and
H(n_{SB},i) is a channel estimate.

Preferably, the rank of the selected first UE is selected according to a Signal-to-interference-plus-noise ratio (SINR).

Preferably, the rank r_{\hat{k}} of the selected first UE \hat{k} is selected according to:

$${r}_{\hat{k}} = {arg max}_{r ∈ \{ 1 , … , {N}_{RX} ( \hat{k} ) \}} {\sum }_{{n}_{SB} = 1}^{{N}_{SB}} {\sum }_{l = 1}^{r} {log}_{2} ( 1 + SINR ( {n}_{SB} , \hat{k} , l , r ) )$$

$$SINR ( {n}_{SB} , \hat{k} , r , l ) = \frac{ρ}{{[ {ρ}^{- 1} I + {W ( {n}_{SB} , \hat{k} , r )}^{H} {H ( {n}_{SB} , \hat{k} )}^{H} H ( {n}_{SB} , \hat{k} ) W ( {n}_{SB} , \hat{k} , r ) ]}_{H}^{- 1}} - 1$$

$$ρ = \frac{{N}_{RX}}{r} SNR ( {n}_{SB} , \hat{k} )$$

$${n}_{SB} , = 1 , … , {N}_{SB} , r = 1 , … , {N}_{RX} ( \hat{k} ) , l = 1 , … , r$$

where
N_{SB} is the number of subbands in the bandwidth; and
W(n_{SB},i,r) is a precoder;
H(n_{SB},i) is a channel estimate;
N_{RX}(i) is a number of receive channels at UE i;

Preferably, the method comprises:

selecting, at the base station, a further UE of the candidate UEs and a MIMO rank for the selected further UE according to an inter-UE interference between the selected further UE at the MIMO rank and the scheduled UEs; and

scheduling the further UE for transmission, at the MIMO rank, with the scheduled UEs.

Preferably, further UEs are selected, at the base station, until either a rank and/or interference threshold is reached.

Preferably, the interference threshold is determined according to a change in C for each selected UE (î), where:

$$C = {\sum }_{k ∈ Φ} {w}_{k} {\sum }_{{n}_{SB} = 1}^{{N}_{SB}} {\sum }_{l = 1}^{{r}_{k}} {log}_{2} ( 1 + SINR ( {n}_{SB} , [ \hat{i} , {r}_{\hat{i}} ] , k , l ) ) + {w}_{i} {\sum }_{{n}_{SB} = 1}^{{N}_{SB}} {\sum }_{l = 1}^{{r}_{\hat{i}}} {log}_{2} ( 1 + SINR ( {n}_{SB} , \hat{i} , {r}_{\hat{i}} , l ) )$$

Φ is the set of scheduled UEs;
N_{SB} is the number of subbands in the bandwidth;
rₖ is a rank of UE k; and
wᵢ is the weight of UE i. For proportional fair scheduling, the weight may be the reciprocal of the average transmission rate of user i.

Preferably, the rank threshold comprises:

$${r}_{\hat{i}} + {\sum }_{k = 1}^{\vert Φ \vert} R ( k ) \leq {L}_{MAX}$$

where Φ is the set of scheduled UEs;
R(k) is the transmission rank of UE k;
L_{MAX} Maximum number of layers to be used;
Ω is the set of candidate UEs;
rᵢ is the selected rank of the best candidate UE;

In another form, the present invention resides broadly in a MIMO system including:

a base station;

a plurality of UEs, including one or more scheduled UEs, and a plurality of candidate UEs;

wherein the base station is configured to:

select a UE of the candidate UEs and a MIMO rank for the selected UE according to an inter-UE interference between the selected UE at the MIMO rank and the scheduled UEs; and

schedule the UE for transmission, at the MIMO rank, with the scheduled UEs.

Embodiments of the present invention jointly select UE and rank to maximize the total transmission capacity with a type of precoding using a channel estimate.

As the transmission ranks of the UE may be determined at the base-station, inter-UE interference may be taken into account, which may improve overall system performance.

UEs may be selected based on their best transmission rank estimate, so both UE and rank are selected at the same time.

An actual precoder may be used in the UE and rank determination process, to enable accurate inter-UE interference to taken into account.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a general MU-MIMO system, according to the prior art;

FIG. 2 illustrates a downlink and uplink transmission mechanism between the eNB and the UEs of the system of FIG. 1.

FIG. 3 illustrates a method of scheduling UE transmission in a MIMO system, according to an embodiment of the present invention;

FIG. 4 illustrates a method of selecting the first UE and its transmission rank that may be employed in the method of FIG. 3.

FIG. 5 illustrates a method of selecting subsequent UEs and their transmission rank that may be employed in the method of FIG. 3.

FIG. 6 illustrates a method of computing precoders for a UE that may be employed in the method of FIG. 4.

FIG. 7 illustrates a method of computing precoders for UEs that may be employed in the method of FIG. 5.

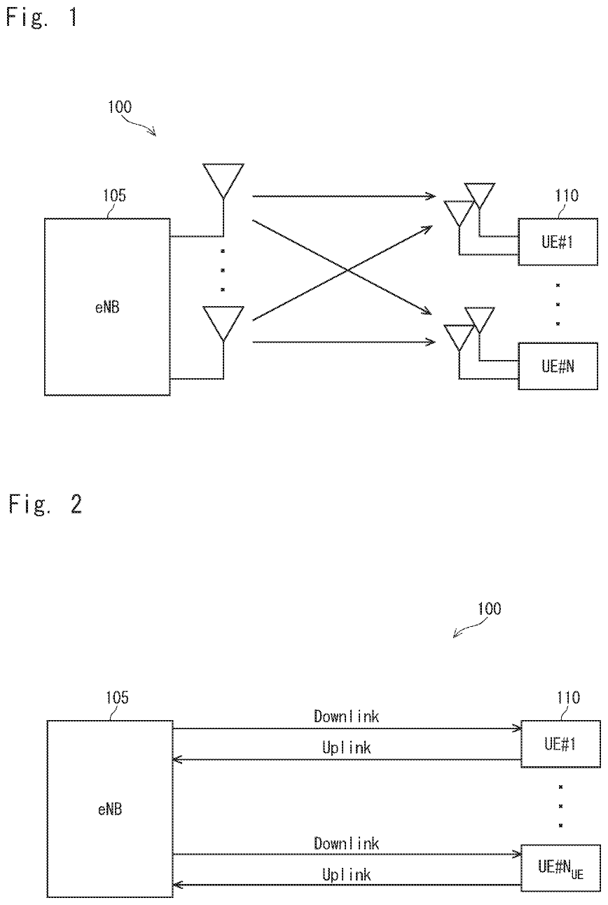

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

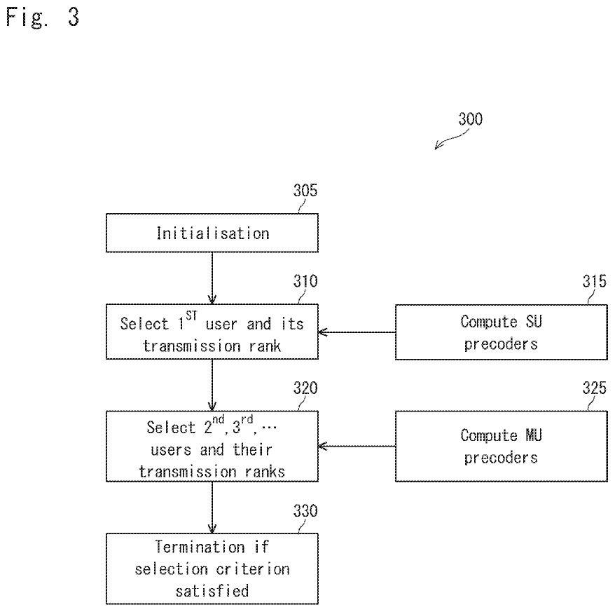

FIG. 3 illustrates a method 300 of scheduling UE transmission in a MIMO system, according to an embodiment of the present invention. The method 300 is performed at a base station (eNB), which enables inter-UE interference to be minimised, and includes joint UE selection and rank estimation. As a result, the available bandwidth may be more efficiently utilized.

FIG. 3 illustrates a method 300 of scheduling UE transmission in a MIMO system, according to an embodiment of the present invention. The method 300 is performed at a base station (eNB), which enables inter-UE interference to be minimised, and includes joint UE selection and rank estimation. As a result, the available bandwidth may be more efficiently utilized.

TABLE 1
Input, output and control parameters of the method 300

| Name | Rate | Description |
|---|---|---|
| Ω = {1, 2, . . . , N} | subframe | Set of candidate UEs to be scheduled |
| H(n_{SB}, i), i ϵ Ω | subframe | Channel estimate for the n_{SB} subband |
| | | of the i UE of size N_{RX} (i) × N_{TX}. |
| SNR(n_{SB}, i), i ϵ Ω | subframe | SNR of the n_{SB} subband of the i-th UE |
| Φ | subframe | Set of scheduled UEs |
| R | subframe | Transmission-ranks of the selected UEs |
| N_{SB} | | Number of subbands in the bandwidth |
| L_{MAX} | | Maximum number of layers to be used |
| ε | | Capacity threshold |
| N_{TX} | | Number of transmit antennas at eNB |
| N_{Rx} (i) | | Number of receiver antennas at UE i |
| wᵢ, i ϵ Ω | | Weight of user i. For proportional fair |
| | | scheduling, it is the reciprocal of the |
| | | average rate of user i |

At step 305, data outputs and variables of the system are initialised. In particular, the set of scheduled UEs Φ is initialised to an empty set, the transmission ranks R is set to an empty array of size N_{UE}×1, and the current UE variable n_{UE}=1.

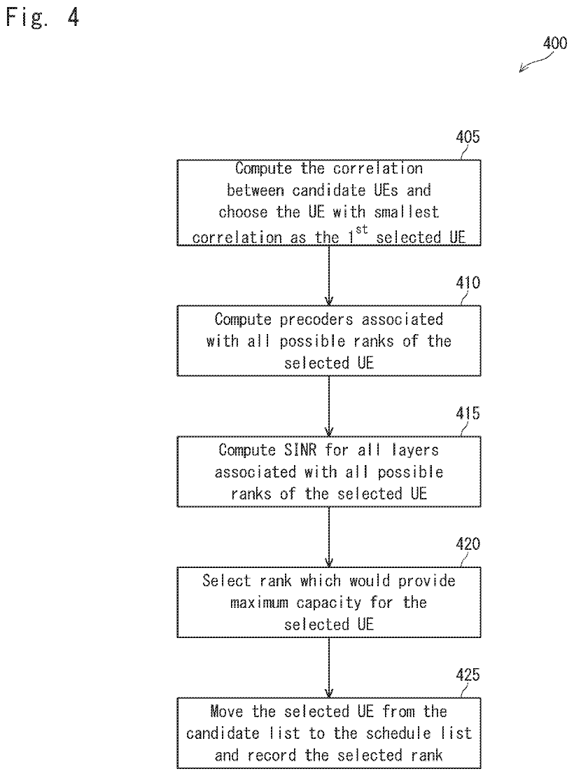

At step 310, a first UE and its transmission rank is determined. As described in further detail below, FIG. 4 illustrates a method of selecting the first UE and its transmission rank that may be employed in step 310.

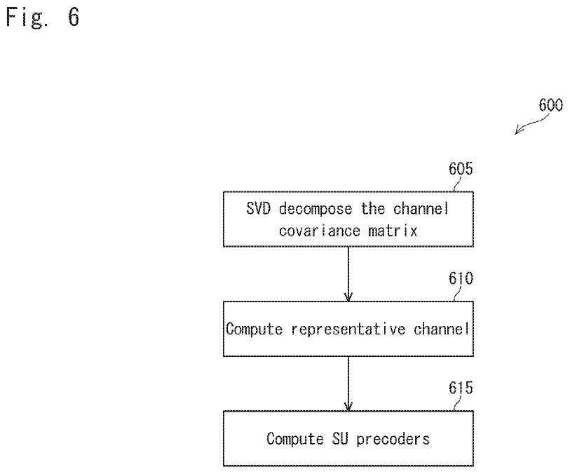

At step 315, precoders for the first UE are computed, and provided as input into step 310. As described in further detail below, FIG. 6 illustrates a method of computing precoders that may be employed in step 315.

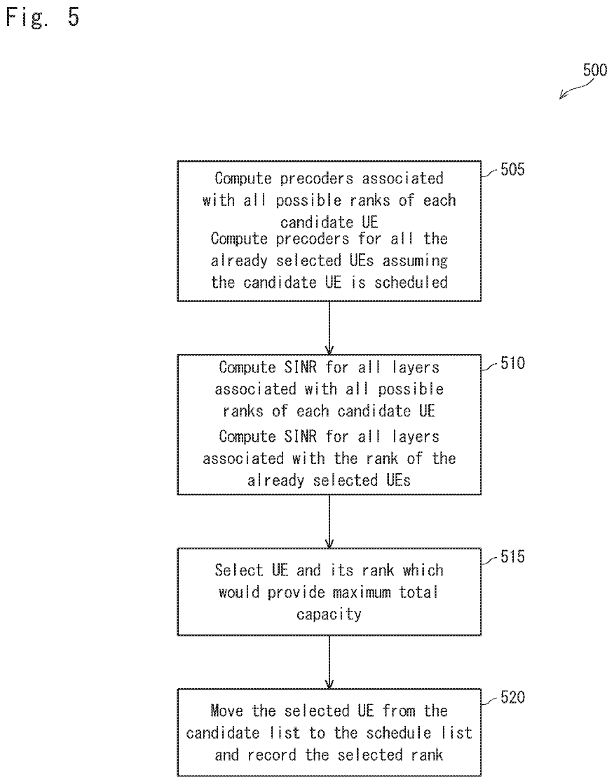

At step 320, the subsequent UEs and their transmission rank are determined. As described in further detail below, FIG. 5 illustrates a method of selecting subsequent UEs and their transmission rank that may be employed in step 320.

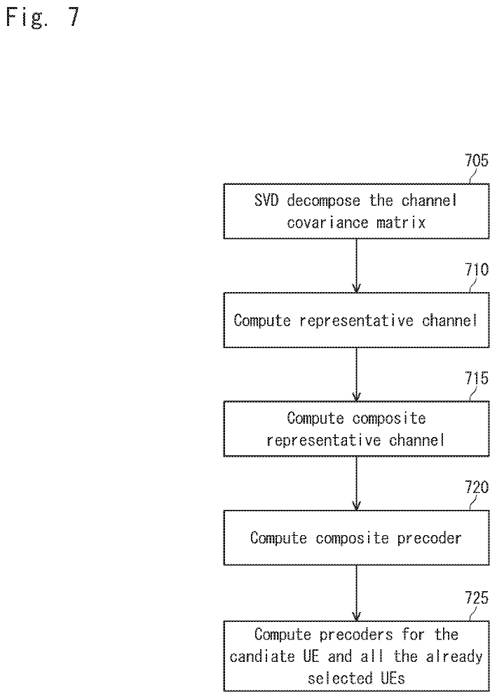

At step 325, precoders for the subsequent UEs are computed, and provided as input into step 320. As described in further detail below, FIG. 7 illustrates a method of computing precoders that may be employed in step 325.

Finally, at step 330, the method is terminated if selection criteria are satisfied. In particular, subsequent UEs are selected in step 320 until predefined selection criteria are met, as outlined below.

FIG. 4 illustrates a method of selecting the first UE and its transmission rank, according to an embodiment of the present invention.

At step 405, a correlation between UEs is calculated, and the UE with the smallest correlation \hat{k} is selected as follows:

$$\hat{k} = {arg min}_{k ∈ Ω} {\sum }_{{n}_{SB} = 1}^{{N}_{SB}} {\sum }_{i ∈ Ω , i \neq k} tr \{ {[ H ( {n}_{SB} , i ) {H ( {n}_{SB} , k )}^{H} ]}^{H} [ H ( {n}_{SB} , i ) {H ( {n}_{SB} , k )}^{H} ] \} \qquad ( Equation 2 )$$

where tr indicates a trace of the resultant matrix, and [ ]^{H} is the Hermitian transpose.

As discussed above, H(n_{SB},i), i∈Ω is a channel estimate for the n_{SB} subband of the i^{th} UE, having a size N_{RX}(i)×N_{TX}.

At step 410, precoders W(n_{SB},\hat{k},r) and representative channel matrices G(n_{SB},\hat{k},r) of all possible ranks r∈{1, . . . , N_{RX}(i)} for the selected UE k are determined. As described in further detail below, FIG. 6 illustrates a method of computing precoders for a UE that may be employed in step 410.

At step 415, a signal-to-interference-plus-noise ratio SINR(n_{SB},\hat{k},r,l) is calculated for the selected UE \hat{k} for all possible ranks r∈{1, . . . , N_{RX}(i)}, and for all layers l=1, . . . , r according to:

$$SINR ( {n}_{SB} , \hat{k} , r , l ) = \frac{ρ}{{[ {ρ}^{- 1} I + {W ( {n}_{SB} , \hat{k} , r )}^{H} {H ( {n}_{SB} , \hat{k} )}^{H} H ( {n}_{SB} , \hat{k} ) W ( {n}_{SB} , \hat{k} , r ) ]}_{H}^{- 1}} - 1 \\ ρ = \frac{{N}_{RX}}{r} SNR ( {n}_{SB} , \hat{k} ) \\ {n}_{SB} , = 1 , … , {N}_{SB} , r = 1 , … , {N}_{RX} ( \hat{k} ) , l = 1 , … , r \qquad ( Equation 3 )$$

In Equation 3, [ ]ₗₗ⁻¹ denotes the (l,l)-th element of the matrix [ ]⁻¹, which is the inverse of matrix [ ].

At step 420, a rank for the selected UE \hat{k} that provides maximum capacity for the UE is selected according to:

$${r}_{\hat{k}} = {arg max}_{r ∈ \{ 1 , … , {N}_{RX} ( \hat{k} ) \}} {\sum }_{{n}_{SB} = 1}^{{N}_{SB}} {\sum }_{l = 1}^{r} {log}_{2} ( 1 + SINR ( {n}_{SB} , \hat{k} , r , l ) ) \qquad ( Equation 4 )$$

As will be readily appreciated by the skilled addressee, capacity of the MIMO system may be determined according to SINR, where higher SINRs enable higher capacity.

Once the UE and rank is selected, the basis of the selection is saved as:

$${C}_{0} = {w}_{\hat{k}} {\sum }_{{n}_{SB} = 1}^{{N}_{SB}} {\sum }_{l = 1}^{{r}_{k}} {log}_{2} ( 1 + SINR ( {n}_{SB} , \hat{k} , {r}_{\hat{k}} , l ) ) \qquad ( Equation 5 )$$

As discussed in further detail below, C₀ is used with respect to an interference threshold, on which the method may be completed.

At step 425, the selected UE \hat{k} is removed from the set of candidate UEs to be scheduled Ω. The selected UE \hat{k} is added to the set of scheduled UEs Φ, and the rank of the selected UE \hat{k} is added to the transmission-ranks of the selected UEs as R(n_{UE})=r_{\hat{k}}.

The representative channel matrices G(n_{SB},\hat{k},r) may assigned as a composite representative channel for the subband of selected UEs D(n_{SB}) as D(n_{SB}))=G(n_{SB},\hat{k},rₖ) for use in precoder generation, as outlined below.

FIG. 5 illustrates a method 500 of selecting subsequent UEs and their transmission rank, according to an embodiment of the present invention.

At step 505, precoders W(n_{SB},i,r) are determined for all possible ranks r∈{1, . . . , N_{RX}(i)} and for each candidate UE i. Then, for each selected UE k∈Φ, a precoder W(n_{SB},[i,r],k) is determined for the selected rank rₖ. As described in further detail below, FIG. 7 illustrates a method of computing precoders for the UEs that may be employed in step 505.

At step 510, a signal-to-interference-plus-noise ratio SINR(n_{SB},i,r,l) is calculated for each candidate UE i∈Ω, all possible ranks r∈{1, . . . , N_{RX}(i)}, and for all layers l=1, . . . , r according to:

$$SINR ( {n}_{SB} , i , r , l ) = \frac{ρ}{{[ {ρ}^{- 1} I + {W ( {n}_{SB} , i , r )}^{H} {H ( {n}_{SB} , i )}^{H} H ( {n}_{SB} , i ) W ( {n}_{SB} , i , r ) ]}_{H}^{- 1}} - 1 \\ ρ = \frac{{N}_{RX}}{r} SNR ( {n}_{SB} , i ) \\ {n}_{SB} , = 1 , … , {N}_{SB} , r = 1 , … , {N}_{RX} ( i ) , l = 1 , … , r \qquad ( Equation 6 )$$

Furthermore, a signal-to-interference-plus-noise ratio SINR(n_{SB},[i,r],k,l) is calculated for each selected UE k∈Φ for the rank rₖ according to:

$$SINR ( {n}_{SB} , [ i , r ] , k , l ) = \frac{ρ}{{[ {ρ}^{- 1} I + {W ( {n}_{SB} , [ i , r ] , k )}^{H} {H ( {n}_{SB} , k )}^{H} H ( {n}_{SB} , k ) W ( {n}_{SB} , [ i , r ] , k ) ]}_{H}^{- 1}} - 1 \\ ρ = \frac{{N}_{RX}}{{r}_{k}} SNR ( {n}_{SB} , k ) \\ {n}_{SB} , = 1 , … , {N}_{SB} , l = 1 , … , {r}_{k} \qquad ( Equation 7 )$$

At step 515 a UE î and its transmission rank r_{î} is selected to provide maximum capacity according to:

$$[ \hat{i} , {r}_{\hat{i}} ] = {arg max}_{i ∈ Ω , r ∈ \{ 1 , … , {N}_{RX} ( i ) \}} ( {\sum }_{k ∈ Φ} {w}_{k} {\sum }_{{n}_{SB} = 1}^{{N}_{SB}} {\sum }_{l = 1}^{{r}_{k}} {log}_{2} ( 1 + SINR ( {n}_{SB} , [ i , r ] , k , l ) ) + {w}_{i} {\sum }_{{n}_{SB} = 1}^{{N}_{SB}} {\sum }_{l = 1}^{r} {log}_{2} ( 1 + SINR ( {n}_{SB} , i , r , l ) ) ) \qquad ( Equation 8 )$$

Once the UE and rank is selected, the basis of the selection is saved as:

$$C = {\sum }_{k ∈ Φ} {w}_{k} {\sum }_{{n}_{SB} = 1}^{{N}_{SB}} {\sum }_{l = 1}^{{r}_{k}} {log}_{2} ( 1 + SINR ( {n}_{SB} , [ \hat{i} , {r}_{\hat{i}} ] , k , l ) ) + {w}_{i} {\sum }_{{n}_{SB} = 1}^{{N}_{SB}} {\sum }_{l = 1}^{{r}_{\hat{i}}} {log}_{2} ( 1 + SINR ( {n}_{SB} , \hat{i} , {r}_{\hat{i}} , l ) ) \qquad ( Equation 9 )$$

At step 520, while the condition

$${r}_{\hat{i}} + {\sum }_{k = 1}^{\vert Φ \vert} R ( k ) \leq {L}_{MAX} and \frac{C - {C}_{0}}{{C}_{0}} > ɛ$$

is satisfied, the selected UE î is removed from the candidate UEs Ω, and is added to the schedules UEs Φ. The rank of the selected UE î is added to the transmission-ranks of the selected UEs as R(n_{UE})=r_{\hat{k}}. Furthermore, the selected UE i is assigned D(n_{SB})=F(n_{SB},î,r_{î})

The method 500 is repeated over all candidate UEs until a rank threshold and an interference threshold is reached. In particular, if

$$\frac{C - {C}_{0}}{{C}_{0}} \leq ɛ$$

or if

$${r}_{\hat{i}} + {\sum }_{k = 1}^{\vert Φ \vert} R ( k ) > {L}_{MAX}$$

then the method is completed (no longer repeated). Otherwise, C₀=C, n_{UE}=n_{UE}+1 and the method 500 is repeated to assign further candidate UEs.

Note: |Φ| denotes the size (number of elements) of set Φ.

FIG. 6 illustrates a method 600 of generating SU precoders, according to an embodiment of the present invention. In particular, precoders are generated for different transmission-ranks and given channel and SNR estimates.

For the sake of convenience, Table 2, below, provides an overview of the data input to the method 600, the data output of the method 600, and the control parameters used by the method 600.

TABLE 2
Input, output and control parameters of the method 600

| Name | Rate | Description |
|---|---|---|
| H(n_{SB}) | subframe | Channel estimate for the n_{SB}-th subband of size |
| | | N_{RX} × N_{TX} |
| W(n_{SB}, r) | subframe | Precoder matrix of size N_{TX} × r |
| G(n_{SB}, r) | | Representative channel matrix of size r × N_{TX} |
| α | | Regularised parameter |

At step 605, the singular value decomposition (SVD) of a channel covariance matrix H(n_{SB}) is determined according to:

U(n_{SB})Λ(n_{SB})V(n_{SB})=H(n_{SB})^{H}H(n_{SB}) (Equation 10)

At step 610, a representative channel G(n_{SB},r) is determined according to either:

$$\begin{matrix}G ( {n}_{SB} , r ) = {[ \begin{matrix}{U}_{1 , 1} & ⋯ & {U}_{1 , r} \\ ⋮ & ⋮ & ⋮ \\ {U}_{{N}_{TX} , 1} & ⋯ & {U}_{{N}_{TX} , r}\end{matrix} ]}^{H} , r = 1 , … , {N}_{RX} \\ or \text{:} & ( Equation 11 ) \\ G ( {n}_{SB} , r ) = {[ \begin{matrix}\sqrt{{λ}_{1}} & & \\ & ⋱ & \\ & & \sqrt{{λ}_{r}}\end{matrix} ] [ \begin{matrix}{U}_{1 , 1} & ⋯ & {U}_{1 , r} \\ ⋮ & ⋮ & ⋮ \\ {U}_{{N}_{TX} , 1} & ⋯ & {U}_{{N}_{TX} , r}\end{matrix} ]}^{H} , r = 1 , … , {N}_{RX} & ( Equation 12 )\end{matrix}$$

At step 615, precoders W(n_{SB},r) are determined according to:

W(n_{SB},r)=G(n_{SB},r)^{H}[G(n_{SB},r)G(n_{SB},r)^{H}+αI]⁻¹, r=1, . . . ,N_{RX} (Equation 13)

FIG. 7 illustrates a method 700 of generating MU precoders, according to an embodiment of the present invention. In particular, precoders are generated for different transmission-ranks and given channel and SNR estimates.

For the sake of convenience, Table 3, below, provides an overview of the data input to the method 700, the data output of the method 700, and the control parameters used by the method 700.

TABLE 3
Input, output and control parameters of the method 700

| Name | Rate | Description |
|---|---|---|
| H(n_{SB}, i), i ϵ Ω | subframe | Channel estimate for the n_{SB} subband of |
| | | the iUE of size N_{RX} (i) × N_{TX} |
| D(n_{SB}) | | Composite representative channel for the |
| | | n_{SB} subband of selected UEs |
| Φ | subframe | Set of scheduled UEs |
| R | subframe | Array contains transmission-ranks of the |
| | | selected UEs |
| W(n_{SB}, i, r), i ϵ Ω | subframe | Precoder matrix of size N_{TX} × r |
| W(n_{SB}, [i, r], k), k ϵ | subframe | Precoder matrix of size N_{TX} × rₖ |
| F(n_{SB}, i, r), i ϵ Ω | | Composite representative channel matrix |
| α | | Regularised parameter |

At step 705, the singular value decomposition (SVD) of a channel covariance matrix H(n_{SB},i) is determined according to:

U(n_{SB},i)Λ(n_{SB},i)V(n_{SB},i)=H(n_{SB},i)^{H}H(n_{SB},i), i∈Ω (Equation 14)

At step 710, a representative channel G(n_{SB},i,r) is determined according to either:

$$\begin{matrix}G ( {n}_{SB} , i , r ) = {[ \begin{matrix}{U}_{1 , 1} & ⋯ & {U}_{1 , r} \\ ⋮ & ⋮ & ⋮ \\ {U}_{{N}_{TX} , 1} & ⋯ & {U}_{{N}_{TX} , r}\end{matrix} ]}^{H} , r = 1 , … , {N}_{RX} ( i ) \\ or \text{:} & ( Equation 15 ) \\ G ( {n}_{SB} , i , r ) = {[ \begin{matrix}\sqrt{{λ}_{1}} & & \\ & ⋱ & \\ & & \sqrt{{λ}_{r}}\end{matrix} ] [ \begin{matrix}{U}_{1 , 1} & ⋯ & {U}_{1 , r} \\ ⋮ & ⋮ & ⋮ \\ {U}_{{N}_{TX} , 1} & ⋯ & {U}_{{N}_{TX} , r}\end{matrix} ]}^{H} , r = 1 , … , {N}_{RX} ( i ) & ( Equation 16 )\end{matrix}$$

At step 715, a composite representative channel F(n_{SB},i,r) for all possible ranks r∈{1, . . . , N_{RX}(i)}. is determined according to:

$$F ( {n}_{SB} , i , r ) = [ \begin{matrix}D ( {n}_{SB} ) \\ G ( {n}_{SB} , i , r )\end{matrix} ] , r = 1 , … , {N}_{RX} ( i ) \qquad ( Equation 17 )$$

At step 720, a composite precoder P(n_{SB},i,r) is determined according to:

P(n_{SB},i,r)=F(n_{SB},i,r)^{H}[F(n_{SB},i,r)F(n_{SB},i,r)^{H}+αI]⁻¹, r=1, . . . ,NR_{RX}(i) (Equation 18)

At step 725, compute the precoder for the UE i and the already selected UEs according to:

$$\begin{matrix}W ( {n}_{SB} , [ i , r ] , k ) = [ \begin{matrix}{P}_{1 , {N}_{k}} & ⋯ & {P}_{1 , {N}_{k} + R ( k ) - 1} \\ ⋮ & ⋮ & ⋮ \\ {P}_{{N}_{TX} , {N}_{k}} & ⋯ & {P}_{{N}_{TX} , {N}_{k} + R ( k ) - 1}\end{matrix} ] , {N}_{k} = 1 + {\sum }_{j = 1}^{k - 1} R ( j ) , k = 1 , 2 , … , \vert Φ \vert \\ and & ( Equation 19 ) \\ W ( {n}_{SB} , i , r ) = [ \begin{matrix}{P}_{1 , {N}_{i}} & ⋯ & {P}_{1 , {N}_{i} + r - 1} \\ ⋮ & ⋮ & ⋮ \\ {P}_{{N}_{TX} , {N}_{i}} & ⋯ & {P}_{{N}_{TX} , {N}_{i} + r - 1}\end{matrix} ] , {N}_{i} = 1 + {\sum }_{k = 1}^{\vert Φ \vert} R ( k ) , r = 1 , 2 , … , {N}_{RX} ( i ) & ( Equation 20 )\end{matrix}$$

The embodiments of the invention described above include joint selection of UE and rank to maximize the total transmission capacity with a type of precoding using a channel estimate. As the transmission ranks of the UE may be determined at the base-station, inter-UE interference may be taken into account, which may improve overall system performance.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

This application is based upon and claims the benefit of priority from Australian provisional patent application No. 2016903340, filed on Aug. 23, 2016, the disclosure of which is incorporated herein in its entirety by reference.

### REFERENCE SIGNS LIST

100 MU-MIMO system
105 eNB
110 UEs

1. A method of scheduling transmission in a MIMO system comprising a base station, one or more scheduled UEs and a plurality of candidate UEs, the method comprising:
selecting, at the base station, a UE of the candidate UEs and a MIMO rank for the selected UE according to an inter-UE interference between the selected UE at the MIMO rank and the scheduled UEs; and
scheduling the UE for transmission, at the MIMO rank, with the scheduled UEs.

2. The method of claim 1, wherein the inter-UE interference is determined according to a signal-to-interference-plus-noise ratio (SINR) of the selected UE and each of the scheduled UEs.

3. The method of claim 1, wherein the UE is selected by:
determining an inter-UE interference for each of the candidate UEs and the scheduled UEs; and
selecting the UE of the candidate UEs according to the determined inter-UE interferences.

4. The method of claim 3, wherein the inter-UE interference for each of the candidate UEs is determined for each of a plurality of MIMO ranks, and the UE and MIMO rank are jointly selected according to the determined inter-UE interferences.

5. The method of claim 4, further comprising: determining a composite precoder for each of the candidate UEs and the scheduled UEs, and determining the inter-UE interference using the composite precoders and channel estimates.

6. The method of claim 5, wherein the precoder determined according to singular value decomposition (SVD) of a channel estimate.

7. The method of claim 4, wherein the selected UE (i) and rank (is selected according to:
$$[ \hat{i} , {r}_{\hat{i}} ] = {arg max}_{i ∈ Ω , r ∈ \{ 1 , … , {N}_{RX} ( i ) \}} ( {\sum }_{k ∈ Φ} {w}_{k} {\sum }_{{n}_{SB} = 1}^{{N}_{SB}} {\sum }_{l = 1}^{{r}_{k}} {log}_{2} ( 1 + SINR ( {n}_{SB} , [ i , r ] , k , l ) ) + {w}_{i} {\sum }_{{n}_{SB} = 1}^{{n}_{SB}} {\sum }_{l = 1}^{r} {log}_{2} ( 1 + SINR ( {n}_{SB} , i , r , l ) ) )$$
where:
Ω is the set of candidate UEs;
N_{RX}(i) is the number of receiver channels at UE i;
Φ is the set of scheduled UEs;
N_{SB} is the number of subbands in the bandwidth; and
rₖ is the rank of UE k wᵢ is the weight of UE i.

8. The method of claim 6, wherein:
SINR(n_{SB},i,r,l) is determined according to:
$$SINR ( {n}_{SB} , i , r , l ) = \frac{ρ}{{[ {ρ}^{- 1} I + {W ( {n}_{SB} , i , r )}^{H} {H ( {n}_{SB} , i )}^{H} H ( {n}_{SB} , i ) W ( {n}_{SB} , i , r ) ]}_{H}^{- 1}} - 1$$
$$ρ = \frac{{N}_{RX}}{r} SNR ( {n}_{SB} , i ) ; and$$
$${n}_{SB} = 1 , … , {N}_{SB} , r = 1 , … , {N}_{RX} ( i ) , l = 1 , … , r$$
SINR(n_{SB},[i,r],k,l) is determined according to:
$$SINR ( {n}_{SB} , [ i , r ] , k , l ) = \frac{ρ}{{[ {ρ}^{- 1} I + {W ( {n}_{SB} , [ i , r ] , k )}^{H} {H ( {n}_{SB} , k )}^{H} H ( {n}_{SB} , k ) W ( {n}_{SB} , [ i , r ] , k ) ]}_{H}^{- 1}} - 1 \\ ρ = \frac{{N}_{RX}}{{r}_{k}} SNR ( {n}_{SB} , k )$$
$${n}_{SB} = 1 , … , {N}_{SB} , l = 1 , … , {r}_{k}$$
where
W(n_{SB},i,r) is a precoder;
H(n_{SB},i) is a channel estimate;
N_{RX}(i) is a number of receive antennas at UE i;
rₖ is a rank of UE k; and
SNR is a signal to noise ratio.

9. The method of claim 7, wherein the precoder W(n_{SB},i,r) is determined according to:
$$W ( {n}_{SB} , i , r ) = [ \begin{matrix}{P}_{1 , {N}_{i}} & ⋯ & {P}_{1 , {N}_{i} + r - 1} \\ ⋮ & ⋮ & ⋮ \\ {P}_{{N}_{TX} , {N}_{i}} & ⋯ & {P}_{{N}_{TX} , {N}_{i} + r - 1}\end{matrix} ] , {N}_{i} = 1 + {\sum }_{k = 1}^{\vert Φ \vert} R ( k ) , r = 1 , 2 , … , {N}_{RX} ( i )$$
$$P ( {n}_{SB} , i , r ) = {{F ( {n}_{SB} , i , r )}^{H} [ F ( {n}_{SB} , i , r ) {F ( {n}_{SB} , i , r )}^{H} + α I ]}^{- 1} , r = 1 , … , {N}_{RX} ( i )$$
where
F is a composite representative channel; and
N_{RX}(i) is a number of receive antennas at UE i.

10. The method of claim 1, wherein the scheduled UEs include a first UE, which was selected to be scheduled based upon a smallest correlation with other UEs according to channel estimates.

11. The method of claim 10, wherein the first UE (\hat{k}) is selected according to
$$\hat{k} = {arg min}_{k ∈ Ω} {\sum }_{{n}_{SB} = 1}^{{N}_{SB}} {\sum }_{i ∈ Ω , i \neq k} tr \{ {[ H ( {n}_{SB} , i ) {H ( {n}_{SB} , k )}^{H} ]}^{H} [ H ( {n}_{SB} , i ) {H ( {n}_{SB} , k )}^{H} ] \}$$
where
Ω is the set of candidate UEs;
N_{SB} is the number of subbands in the bandwidth; and
H(n_{SB},i) is a channel estimate.

12. The method of claim 10, wherein the rank of the selected first UE is selected according to a Signal-to-interference-plus-noise ratio (SINR).

13. The method of claim 12, wherein the rank r_{\hat{k}} of the selected first UE \hat{k} is selected according to:
$${r}_{\hat{k}} = {arg max}_{r ∈ \{ 1 , … , {N}_{RX} ( \hat{k} ) \}} {\sum }_{{n}_{SB} = 1}^{{N}_{SB}} {\sum }_{l = 1}^{r} {log}_{2} ( 1 + SINR ( {n}_{SB} , \hat{k} , r , l ) )$$
$$SINR ( {n}_{SB} , \hat{k} , r , l ) = \frac{ρ}{{[ {ρ}^{- 1} I + {W ( {n}_{SB} , \hat{k} , r )}^{H} {H ( {n}_{SB} , \hat{k} )}^{H} H ( {n}_{SB} , \hat{k} ) W ( {n}_{SB} , \hat{k} , r ) ]}_{H}^{- 1}} - 1$$
$$ρ = \frac{{N}_{RX}}{r} SNR ( {n}_{SB} , \hat{k} )$$
$${n}_{SB} , = 1 , … , {N}_{SB} , r = 1 , … , {N}_{RX} ( \hat{k} ) , l = 1 , … , r$$
where
N_{SB} is the number of subbands in the bandwidth; and
W(n_{SB},i,r) is a precoder;
H(n_{SB},i) is a channel estimate;
N_{RX}(i) is a number of receive antennas at UE i;

14. The method of claim 1, further comprising:
selecting, at the base station, a further UE of the candidate UEs and a MIMO rank for the selected further UE according to an inter-UE interference between the selected further UE at the MIMO rank and the scheduled UEs; and
scheduling the further UE for transmission, at the MIMO rank, with the scheduled UEs.

15. The method of claim 14, wherein further UEs are selected, at the base station, until a rank and/or interference threshold is reached.

16. The method of claim 15, wherein the interference threshold is determined according to a change in C for each selected UE (î), where:
$$C = {\sum }_{k ∈ Φ} {w}_{k} {\sum }_{{n}_{SB} = 1}^{{N}_{SB}} {\sum }_{l = 1}^{{r}_{k}} {log}_{2} ( 1 + SINR ( {n}_{SB} , [ \hat{i} , {r}_{\hat{i}} ] , k , l ) ) + {w}_{i} {\sum }_{{n}_{SB} = 1}^{{N}_{SB}} {\sum }_{l = 1}^{{r}_{\hat{i}}} {log}_{2} ( 1 + SINR ( {n}_{SB} , \hat{i} , {r}_{\hat{i}} , l ) )$$
Φ is the set of scheduled UEs;
N_{SB} is the number of subbands in the bandwidth; and
rₖ is a rank of UE k.
wᵢ is the weight of UE i.

17. The method of claim 15, wherein the rank threshold comprises:
$${r}_{\hat{i}} + {\sum }_{k = 1}^{\vert Φ \vert} R ( k ) \leq {L}_{MAX}$$
where Φ is the set of scheduled UEs;
R(k) is the transmission rank of UE k;
L_{MAX} Maximum number of layers to be used;
Ω is the set of candidate UEs;
r_{î} is the selected rank of the best candidate UE;

18. A MIMO system including:
a base station;
a plurality of UEs, including one or more scheduled UEs, and a plurality of candidate UEs;
wherein the base station is configured to:
select a UE of the candidate UEs and a MIMO rank for the selected UE according to an inter-UE interference between the selected UE at the MIMO rank and the scheduled UEs; and
schedule the UE for transmission, at the MIMO rank, with the scheduled UEs.
